(19) United States
(12) Patent Application Publication
(10) Pub. No.: US 2024/0291986 A1
(43) Pub. Date: Aug. 29, 2024

(54) CODING OF LAST SIGNIFICANT COEFFICIENT IN A BLOCK OF A PICTURE

(71) Applicant: InterDigital CE Patent Holdings, SAS, Paris (FR)

(72) Inventors: Karam Naser, Mouaze (FR); Fabrice Le Leannec, Betton (FR); Tangi Poirier, Thorigne-Fouillard (FR); Franck Galpin, Thorigne-Fouillard (FR)

(21) Appl. No.: 18/568,155

(22) PCT Filed: May 23, 2022
(86) PCT No.: PCT/EP2022/063895

§ 371 Date: Dec. 7, 2023

(30) Foreign Application Priority Data
Jun. 14, 2021 (EP) 21305809.2

(51) Int. Cl. H04N 19/12; H04N 19/176; H04N 19/18

(52) U.S. Cl. CPC H04N 19/12; H04N 19/176; H04N 19/18

(57) ABSTRACT

A method comprising: determining (701) that a zeroing process was applied to a block of transform coefficients; and, decoding (702) a position of a last significant coefficient of the block in scanning order with respect to a position in the block depending on the applied zeroing process.

### 1. TECHNICAL FIELD

At least one of the present embodiments generally relates to a method and a device for coding and decoding a last significant coefficient in a block of a picture.

### 2. BACKGROUND

To achieve high compression efficiency, video coding schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

One key aspect when encoding a sub-block of transform coefficients is the signaling of a position of a last significant coefficient of the sub-block. A last significant coefficient of a sub-block is the last non-zero coefficient in scanning order in this sub-block after transform and quantization. Several strategies can be applied to signal the position of the last significant coefficient with a limited rate and distortion cost. For example, one strategy consists in signaling the position of the last significant coefficient with respect to the top-left corner of the sub-block while another consists in signaling the position of the last significant coefficient with respect to the bottom-right corner of the sub-block. The main issue with these strategies is that they are mainly based on known signal properties after transform and quantization but ignore that some encoding modes impose zeroing of some coefficients in function of the position of these coefficients in the sub-block. Coefficient that would have been non-zero after transform and quantization are set to zero if they are at a given position.

It is desirable to propose solutions allowing to overcome the above issues. In particular, it is desirable to propose a solution allowing considering that an arbitrary zeroing can be applied after the transform and the quantization of a block in the signaling of the last significant coefficient of a block.

### 3. BRIEF SUMMARY

In a first aspect, one or more of the present embodiments provide a method comprising: determining that a zeroing process was applied to a block of transform coefficients; and, decoding a position of a last significant coefficient of the block in scanning order with respect to a position in the block depending on the applied zeroing process.

In an embodiment, an actual applying of the zeroing process to the block is determined in function of a type of transform process applied to the block.

In an embodiment, a type of zeroing process is determined in function of a type of transform process applied to the block.

In an embodiment, the position in the block depending on the applied zeroing process is a position of a top-left coefficient in the block or a position of a bottom-right coefficient in the block or a position in the block having a value of a coordinate equal to a maximum allowable value depending on the zeroing process.

In a second aspect, one or more of the present embodiments provide a method comprising: determining that a zeroing process was applied to a block of transform coefficients; and, signaling a position of a last significant coefficient of the block in scanning order with respect to a position in the block depending on the applied zeroing process.

In an embodiment, an actual applying of the zeroing process to the block is determined in function of a type of transform process applied to the block.

In an embodiment, a type of zeroing process is determined in function of a type of transform process applied to the block.

In an embodiment, the position in the block depending on the applied zeroing process is a position of a top-left coefficient in the block or a position of a bottom-right coefficient in the block or a position in the block having a value of a coordinate equal to a maximum allowable value depending on the zeroing process.

In a third aspect, one or more of the present embodiments provide a device comprising an electronic circuitry adapted for: determining that a zeroing process was applied to a block of transform coefficients; and, decoding a position of a last significant coefficient of the block in scanning order with respect to a position in the block depending on the applied zeroing process.

In an embodiment, an actual applying of the zeroing process to the block is determined in function of a type of transform process applied to the block.

In an embodiment, a type of zeroing process is determined in function of a type of transform process applied to the block.

In an embodiment, the position in the block depending on the applied zeroing process is a position of a top-left coefficient in the block or a position of a bottom-right coefficient in the block or a position in the block having a value of a coordinate equal to a maximum allowable value depending on the zeroing process.

In a fourth aspect, one or more of the present embodiments provide a device comprising an electronic circuitry adapted for: determining that a zeroing process was applied to a block of transform coefficients; and, signaling a position of a last significant coefficient of the block in scanning order with respect to a position in the block depending on the applied zeroing process.

In an embodiment, an actual applying of the zeroing process to the block is determined in function of a type of transform process applied to the block.

In an embodiment, a type of zeroing process is determined in function of a type of transform process applied to the block.

In an embodiment, the position in the block depending on the applied zeroing process is a position of a top-left coefficient in the block or a position of a bottom-right coefficient in the block or a position in the block having a value of a coordinate equal to a maximum allowable value depending on the zeroing process.

In a fifth aspect, one or more of the present embodiments provide a signal generated by the method of the second aspect or by the device of the fourth aspect.

In a sixth aspect, one or more of the present embodiments provide a computer program comprising program code instructions for implementing the methods of the first or second aspect.

In a seventh aspect, one or more of the present embodiment provide a non-transitory information storage medium storing program code instructions for implementing the method of the first or second aspect.

### 4. BRIEF SUMMARY OF THE DRAWINGS

FIG. 1A represents repartitions of non-zero coefficients in a block;

FIG. 1B depicts a first example of a transform block wherein a zeroing is performed;

FIG. 1C depicts a second example of a transform block wherein a zeroing is performed;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of video streaming system in which embodiments are implemented;

FIG. 5B illustrates schematically an example of hardware architecture of a processing module able to implement an encoding module or a decoding module in which various aspects and embodiments are implemented;

FIG. 5C illustrates a block diagram of an example of a first system in which various aspects and embodiments are implemented;

FIG. 5D illustrates a block diagram of an example of a second system in which various aspects and embodiments are implemented;

FIG. 6 illustrates schematically an application of an embodiment during an encoding process;

FIG. 7 represents schematically an application of an embodiment during a decoding process; and,

FIG. 8 illustrates a zeroing process applied in LFNST.

### 5. DETAILED DESCRIPTION

The following examples of embodiments are described in the context of a video format similar to VVC (Versatile Video Coding (VVC) under development by a joint collaborative team of ITU-T and ISO/IEC experts known as the Joint Video Experts Team (JVET)). However, these embodiments are not limited to the video coding/decoding method corresponding to VVC. These embodiments are in particular adapted to various video formats comprising for example HEVC (ISO/IEC 23008-2-MPEG-H Part 2, High Efficiency Video Coding/ITU-T H.265)), AVC ((ISO/CEI 14496-10), EVC (Essential Video Coding/MPEG-5), AV1 and VP9.

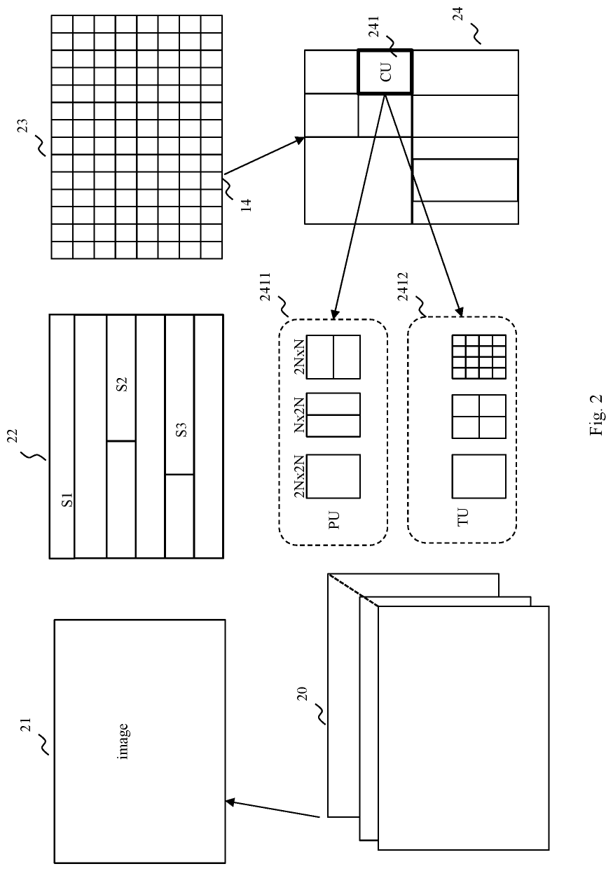

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. Nis generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

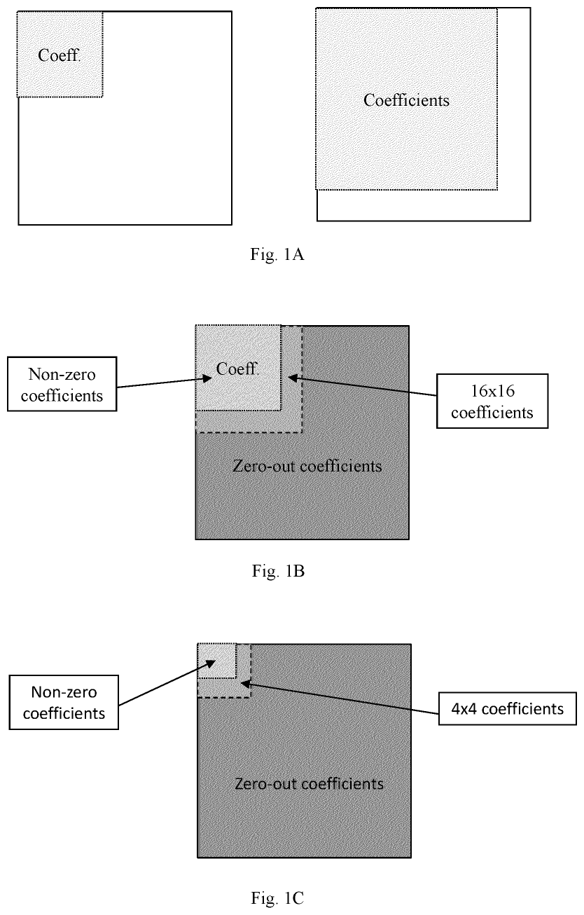

As represented by reference 24 in FIG. 1, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 1, the CTU 14 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 1, a CU of size 2N×2N, can be divided in PU 2411 of size N×2N or of size 2N×N. In addition, said CU can be divided in “4” TU 2412 of size N×N or in “16” TU of size

$$( \frac{N}{2} ) \times ( \frac{N}{2} ) .$$

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

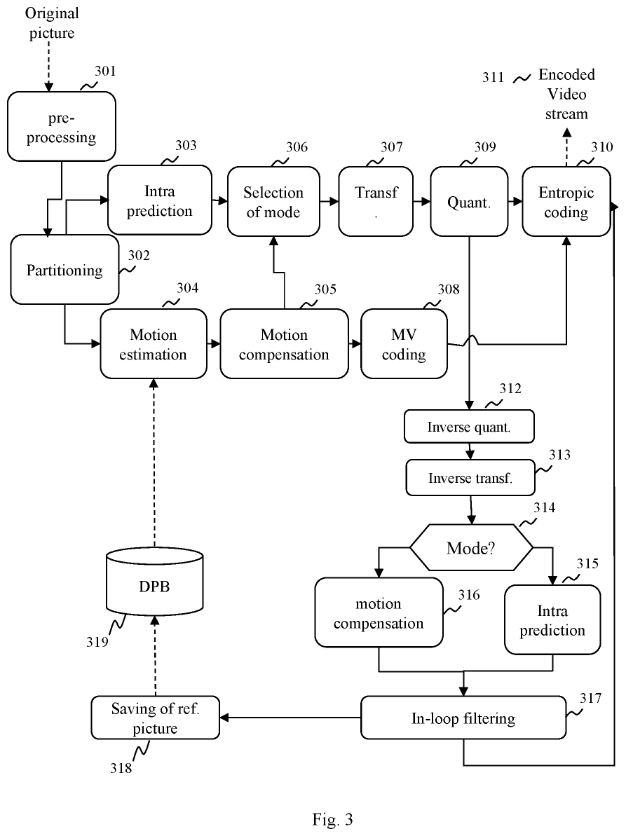

FIG. 3 depicts schematically a method for encoding a video stream executed by an encoding module. Variations of this method for encoding are contemplated, but the method for encoding of FIG. 3 is described below for purposes of clarity without describing all expected variations.

Before being encoded, a current original picture of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). Pictures obtained by pre-processing are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc. For each block, the encoding module determines a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block.

The inter prediction consists of predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307. In some implementations, a plurality of type of transforms can be applied to a transformed residual block. Indeed, in addition to DCT-II, a Multiple Transform Selection (MTS) scheme is used for both inter and intra predicted blocks. It uses multiple selected transforms from the DCT-VIII/DST-VII. The basis functions of the different transforms are represented in table TAB1.

TABLE TAB1

| Transform type | Basis functions |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

Another scheme related to the transform called Low-frequency non-separable transform (LFNST) has been proposed. LFNST is applied between a forward primary transform (i.e. the usual transform of step 307) and a quantization (corresponding to a step 309). In LFNST, a 4×4 non-separable transform or a 8×8 non-separable transform is applied according to block size. For example, a 4×4 LFNST is applied for small blocks and a 8×8 LFNST is applied for larger blocks.

Both LFNST and MTS impose a zeroing (i.e. zero-out) to the transform coefficients, i.e. the value of some coefficients is imposed to be zero in function of their position in the block.

Specifically, for MTS, when the transform length is “32”, the first “16” coefficients in scanning order are kept, and the last “16” coefficients are set to zero. Typically therefore, when MTS is applied, a zeroing process is applied to the transform coefficients when a DST-VII or a DCT-VIII is applied but not when a DCT-II is applied. An example of block on which is applied the zeroing process of MTS (in dark grey) is shown in FIG. 1B.

For LFNST, if the transform block size it 4×4 (respectively 8×8), only the first “8” coefficients in scanning order are not zero, (respectively the first “16” coefficients are non-zero). An example of 32×32 transform block on which is applied the zeroing process of LFNST (in dark grey) is shown FIG. 1C.

The transformed block is then quantized during a step 309.

Note that the encoding module can skip the transform and apply quantization directly to the non-transformed residual signal. When the current block is coded according to an intra prediction mode, a prediction direction and the transformed and quantized residual block are encoded by an entropic encoder during a step 310. When the current block is encoded according to an inter prediction, when appropriate, a motion vector of the block is predicted from a prediction vector selected from a set of motion vectors corresponding to reconstructed blocks situated in the vicinity of the block to be coded. The motion information is next encoded by the entropic encoder during step 310 in the form of a motion residual and an index for identifying the prediction vector. The transformed and quantized residual block is encoded by the entropic encoder during step 310.

As already mentioned, one key aspect when encoding a transformed and quantized residual block is the signaling of the last significant coefficient. In some implementations, the signaling of the last significant coefficient is performed by signaling the horizontal and vertical coordinates in the block of this coefficient with respect to the top-left corner of the block. More specifically, each coordinate is encoded in the form of a prefix (last_sig_coeff_x_prefix, last_sig_coeff_y_prefix) and a suffix (last_sig_coeff_x_suffix, last_sig_coeff_y_suffix) as represented by the residual block decoding process called residual coding represented in table TAB2:

TABLE TAB2

```
residual_coding( x0, y0, log2TbWidth, log2TbHeight, cIdx ) {
    ...
  if( log2TbWidth > 0 )
    last_sig_coeff_x_prefix
  if( log2TbHeight > 0 )
    last_sig_coeff_y_prefix
  if( last_sig_coeff_x_prefix > 3 )
    last_sig_coeff_x_suffix
  if( last_sig_coeff_y_prefix > 3 )
    last_sig_coeff_y_suffix
  ...
```

Where log 2TbWidth (respectivelly log 2TbHeight) represents the width (respectivelly the height) of the block, cIdx is a color component and x0 and y0 are representative of the position of the block.

The position of last significant coefficient (LastSignificantCoeffX, LastSignificantCoeffY) is then computed from the prefix and suffix with the following process (called basic derivation process in the following):

| | |
|---|---|
| • | If last_sig_coeff_x_suffix is not present, the following applies: |
| | LastSignificantCoeffX = last_sig_coeff_x_prefix |
| • | Otherwise (last_sig_coeff_x_suffix is present), the following applies: |
| | LastSignificantCoeffX = |
| | ( 1 << ( (last_sig_coeff_x_prefix >> 1 ) − 1 ) ) * |
| | ( 2 + (last_sig_coeff_x_prefix & 1 ) ) + |
| | last_sig_coeff_x_suffix |
| • | If last_sig_coeff_y_suffix is not present, the following applies: |
| | LastSignificantCoeffY = last_sig_coeff_y_prefix |
| • | Otherwise (last_sig_coeff_y_suffix is present), the following applies: |
| | LastSignificantCoeffY = |
| | ( 1 << ( ( last_sig_coeff_y_prefix >> 1 ) − 1 ) ) * |
| | ( 2 + ( last_sig_coeff_y_prefix & 1 ) ) + |
| | last_sig_coeff_y_suffix |

Generally, the position of the last significant coefficient is computed with respect to the top left corner of the block. Indeed, it has been statistically observed that the last significant coefficient is closer to the top left corner of the block. Computing the last significant coefficient from the top left corner allows therefore generally to reduce the bitrate allocated to the encoding of the syntax elements last_sig_coeff_x_suffix, last_sig_coeff_y_suffix, last_sig_coeff_x_prefix and last_sig_coeff_y_prefix. However, it has also been observed that this assumption no more holds for contents with high bit-depth, high bit-rate and/or high frame-rate (called operation range extension contents in the following). Indeed, it has been observed that, for high bit-rate coding, the last significant coefficient is closer to the bottom right corner rather than to the top left corner of the block. This is because for high bitrate, the quantization becomes finer and more non-zero transform coefficients remain in high frequency regions (towards the bottom right of the coding block). This is illustrated in FIG. 1A. FIG. 1A represents a block encoded at a low bitrate on the left and a block encoded at high bitrate on the right. The non-zero coefficients, represented in light grey are closer to the top-left corner in low-bitrate coding, while they are closer (in particular the last significant coefficient) to the bottom right corner in high bitrate coding. Therefore, to improve the coding efficiency, it would be advantageous to encode the position of the last significant coefficient with respect to its distance to the bottom right corner, instead of encoding it with respect to its distance to the top-left corner.

In addition, it can be noted that the signaling of the last significant coefficient doesn't take into account a zeroing (i.e. a zero-out) process applied on the transform coefficients, even though this zeroing process has necessarily a great impact on the position of the last significant coefficient in the block. For instance, when MTS is activated, the non-zero coefficients in high bitrate coding will be closer to the 16×16 border (as represented by the light grey rectangle in FIG. 1B) rather than to the bottom right corner. Indeed, no non-zero coefficients can be found out of the 16×16 square because of the zeroing process. In the case of LFNST, the position of the last significant coefficient (in the light grey square in FIG. 1C) becomes farther from the bottom right corner because of the zeroing process. As can be seen when MTS and LFNST are activated, none of the top-left nor the bottom right corners seem to be necessarily the best starting point for encoding the position of the last significant coefficient.

In the following embodiments, it is proposed to signal the position of the last significant coefficient with respect to a position in the block depending on the eventual zeroing (i.e. zero-out) process applied to the coefficients of the transformed and quantized residual block.

Note that the encoding module can bypass both transform and quantization, i.e., the entropic encoding is applied on the residual without the application of the transform or quantization processes. The result of the entropic encoding is inserted in an encoded video stream 311.

Metadata such as SEI (supplemental enhancement information) messages can be attached to the encoded video stream 311. A SEI message as defined for example in standards such as AVC, HEVC or VVC is a data container associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the prediction direction corresponding to the current block is used for reconstructing the prediction block of the current block. The prediction block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

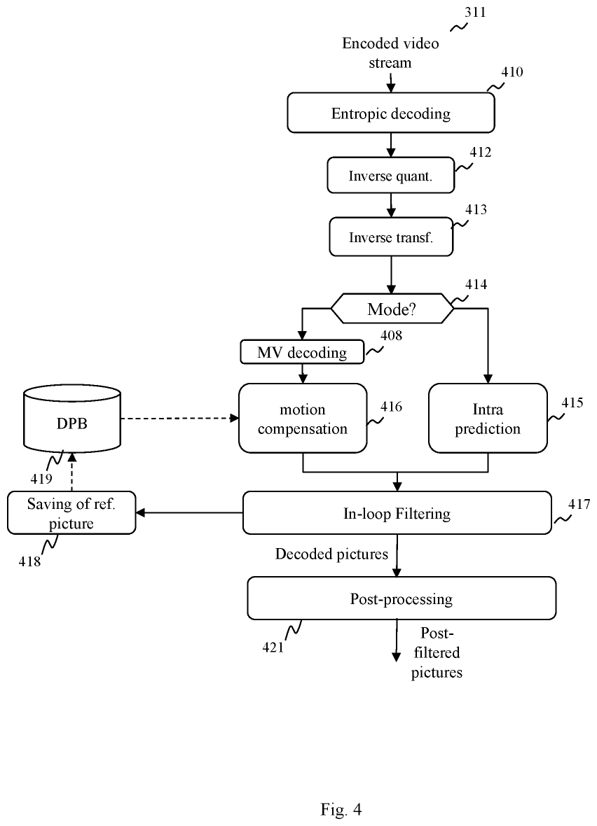

FIG. 4 depicts schematically a method for decoding the encoded video stream 311 encoded according to method described in relation to FIG. 3 executed by a decoding module. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain, at least, the prediction mode of the block. In addition, when appropriate, it allows obtaining the coordinates of the last significant coefficient of a block.

If the block has been encoded according to an inter prediction mode, the entropic decoding allows to obtain, when appropriate, a prediction vector index, a motion residual and a residual block. During a step 408, a motion vector is reconstructed for the current block using the prediction vector index and the motion residual.

If the block has been encoded according to an intra prediction mode, entropic decoding allows to obtain a prediction direction and a residual block. Steps 412, 413, 414, 415, 416 and 417 implemented by the decoding module are in all respects identical respectively to steps 412, 413, 414, 415, 416 and 417 implemented by the encoding module. If MTS was applied to the current block by the encoder, an inverse-transform corresponding to the transform selected by the encoder is applied in step 413. Similarly, if LFNST was applied on the current block on the encoder side, an inverse LFNST transform is applied between the inverse-quantization and an inverse primary transform (between steps 412 and 413).

Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given image. The decoded picture can also be outputted by the decoding module for instance to be displayed.

The post-processing step 421 can comprise an inverse color transform (e.g. conversion from YCbCr 4:2:0 to RGB 4:4:4), an inverse mapping performing the inverse of the remapping process performed in the pre-processing of step 301 and a post-filtering for improving the reconstructed pictures based for example on filter parameters provided in a SEI message.

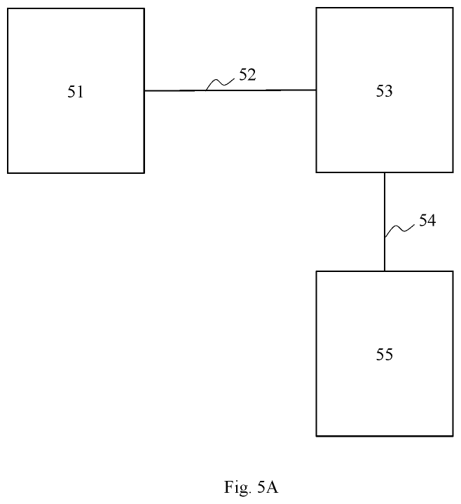

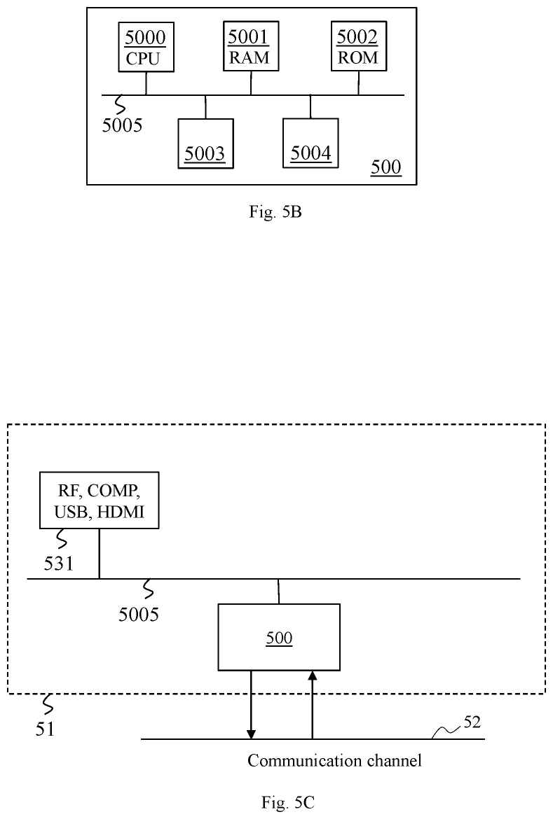

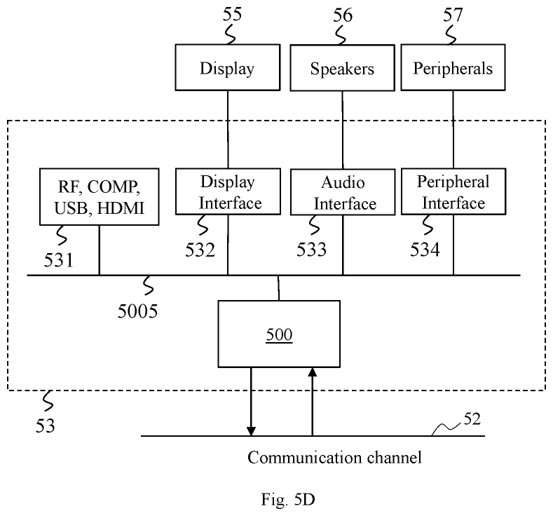

FIG. 5A describes an example of a context in which following embodiments can be implemented.

In FIG. 4A, an apparatus 51, that could be a camera, a storage device, a computer, a server or any device capable of delivering a video stream, transmits a video stream to a system 53 using a communication channel 52. The video stream is either encoded and transmitted by the apparatus 51 or received and/or stored by the apparatus 51 and then transmitted. The communication channel 52 is a wired (for example Internet or Ethernet) or a wireless (for example WiFi, 3G, 4G or 5G) network link.

The system 53, that could be for example a set top box, receives and decodes the video stream to generate a sequence of decoded pictures.

The obtained sequence of decoded pictures is then transmitted to a display system 55 using a communication channel 54, that could be a wired or wireless network. The display system 55 then displays said pictures.

In an embodiment, the system 53 is comprised in the display system 55. In that case, the system 53 and display 55 are comprised in a TV, a computer, a tablet, a smartphone, a head-mounted display, etc.

FIG. 5B illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the apparatus 51 when this apparatus is in charge of encoding the video stream. The decoding module is for example comprised in the system 53. The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or equipment. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

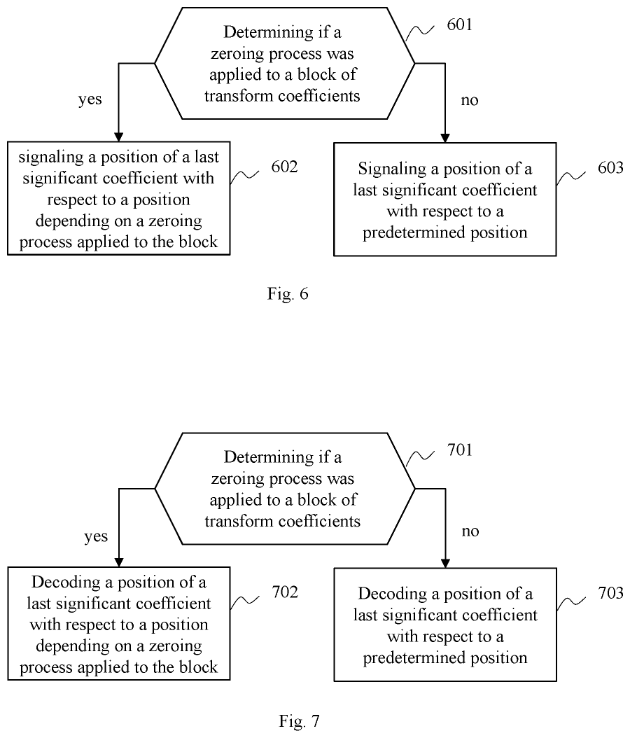

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4, an encoding method described in relation to FIG. 3, and methods described in relation to FIG. 6 or 7, these methods comprising various aspects and embodiments described below in this document.

All or some of the algorithms and steps of the methods of FIGS. 3, 4, 6 and 7 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted to implement at least partially the methods of FIGS. 3, 4, 6 and 7.

FIG. 5D illustrates a block diagram of an example of the system 53 in which various aspects and embodiments are implemented. The system 53 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 53, singly or in combination, can be embodied in a single integrated circuit (IC), multiple ICs, and/or discrete components. For example, in at least one embodiment, the system 53 comprises one processing module 500 that implements a decoding module. In various embodiments, the system 53 is communicatively coupled to one or more other systems, or other electronic devices, via, for example, a communications bus or through dedicated input and/or output ports. In various embodiments, the system 53 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5D, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 53 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 53 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 53, the processing module 500 is interconnected to other elements of said system 53 by the bus 5005.

The communication interface 5004 of the processing module 500 allows the system 53 to communicate on the communication channel 52. As already mentioned above, the communication channel 52 can be implemented, for example, within a wired and/or a wireless medium.

Data is streamed, or otherwise provided, to the system 53, in various embodiments, using a wireless network such as a Wi-Fi network, for example IEEE 802.11 (IEEE refers to the Institute of Electrical and Electronics Engineers). The Wi-Fi signal of these embodiments is received over the communications channel 52 and the communications interface 5004 which are adapted for Wi-Fi communications. The communications channel 52 of these embodiments is typically connected to an access point or router that provides access to external networks including the Internet for allowing streaming applications and other over-the-top communications. Other embodiments provide streamed data to the system 53 using the RF connection of the input block 531. As indicated above, various embodiments provide data in a non-streaming manner. Additionally, various embodiments use wireless networks other than Wi-Fi, for example a cellular network or a Bluetooth network.

The system 53 can provide an output signal to various output devices, including the display system 55, speakers 56, and other peripheral devices 57. The display system 55 of various embodiments includes one or more of, for example, a touchscreen display, an organic light-emitting diode (OLED) display, a curved display, and/or a foldable display. The display 55 can be for a television, a tablet, a laptop, a cell phone (mobile phone), a head mounted display or other devices. The display system 55 can also be integrated with other components (for example, as in a smart phone), or separate (for example, an external monitor for a laptop). The other peripheral devices 57 include, in various examples of embodiments, one or more of a stand-alone digital video disc (or digital versatile disc) (DVR, for both terms), a disk player, a stereo system, and/or a lighting system. Various embodiments use one or more peripheral devices 57 that provide a function based on the output of the system 53. For example, a disk player performs the function of playing an output of the system 53.

In various embodiments, control signals are communicated between the system 53 and the display system 55, speakers 56, or other peripheral devices 57 using signaling such as AV.Link, Consumer Electronics Control (CEC), or other communications protocols that enable device-to-device control with or without user intervention. The output devices can be communicatively coupled to system 53 via dedicated connections through respective interfaces 532, 533, and 534. Alternatively, the output devices can be connected to system 53 using the communications channel 52 via the communications interface 5004 or a dedicated communication channel corresponding to the communication channel 54 in FIG. 5A via the communication interface 5004. The display system 55 and speakers 56 can be integrated in a single unit with the other components of system 53 in an electronic device such as, for example, a television. In various embodiments, the display interface 532 includes a display driver, such as, for example, a timing controller (T Con) chip.

The display system 55 and speaker 56 can alternatively be separate from one or more of the other components. In various embodiments in which the display system 55 and speakers 56 are external components, the output signal can be provided via dedicated output connections, including, for example, HDMI ports, USB ports, or COMP outputs.

FIG. 5C illustrates a block diagram of an example of the system 51 in which various aspects and embodiments are implemented. System 51 is very similar to system 53. The system 51 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 51, singly or in combination, can be embodied in a single integrated circuit (IC), multiple ICs, and/or discrete components. For example, in at least one embodiment, the system 51 comprises one processing module 500 that implements an encoding module. In various embodiments, the system 51 is communicatively coupled to one or more other systems, or other electronic devices, via, for example, a communications bus or through dedicated input and/or output ports. In various embodiments, the system 51 is configured to implement one or more of the aspects described in this document.

The input to the processing module 500 can be provided through various input modules as indicated in block 531 already described in relation to FIG. 5D.

Various elements of system 51 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 51, the processing module 500 is interconnected to other elements of said system 51 by the bus 5005.

The communication interface 5004 of the processing module 500 allows the system 500 to communicate on the communication channel 52.

Data is streamed, or otherwise provided, to the system 51, in various embodiments, using a wireless network such as a Wi-Fi network, for example IEEE 802.11 (IEEE refers to the Institute of Electrical and Electronics Engineers). The Wi-Fi signal of these embodiments is received over the communications channel 52 and the communications interface 5004 which are adapted for Wi-Fi communications. The communications channel 52 of these embodiments is typically connected to an access point or router that provides access to external networks including the Internet for allowing streaming applications and other over-the-top communications. Other embodiments provide streamed data to the system 51 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 51 can be provided in different format. In various embodiments these data are encoded and compliant with a known video compression format such as AV1, VP9, VVC, HEVC, AVC, etc. In various embodiments, these data are raw data provided for example by a picture and/or audio acquisition module connected to the system 51 or comprised in the system 51. In that case, the processing module take in charge the encoding of these data.

The system 51 can provide an output signal to various output devices capable of storing and/or decoding the output signal such as the system 53.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for decoding the last significant coefficient of a block from an encoded video stream.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for signaling a last significant coefficient of a block in an encoded video stream.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream and SEI messages of a described embodiment. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

In the following, various embodiments propose to improve the encoding of the last significant coefficient of a block by better taking into account the application of a zeroing process (i.e. a zero out process), on the transform coefficients of the block.

FIG. 7 represents schematically an application of an embodiment during a decoding process.

The method of FIG. 7 is for example implemented by the system 53, and more precisely by the processing module 500 of the system 53.

In an embodiment, the system 53 receives an encoded video stream from the input modules 531 and decodes this encoded video stream applying for example the method described in relation to FIG. 4. The method of FIG. 7 is applied during the decoding of a current block and more precisely during the decoding of the last significant coefficient of the current block before the inverse quantization and inverse transform of the current block. In FIG. 4, the decoding of the last significant coefficient occurs for example as a sub-step of the entropic decoding step 410.

In a step 701, the processing module 500 of the system 53 determines if a zeroing process (i.e. a zero out process) was applied to the current block of transform coefficients. For example, the processing module 500 of the system 53 determines if the current block was encoded using at least one of MTS or LFNST.

If no zeroing process was applied to the block of transform coefficients, the processing module 500 of the system 53 decodes the position of the last significant coefficient in scanning order with respect to a predetermined position in a step 702. For instance, the predetermined position is the top-left corner of the block if the sequence is encoded in low bitrate. The predetermined position is the bottom right corner of the block if the sequence is encoded in high bitrate. Signaling a position of the last significant coefficient with respect to a predetermined position in a block means that each coordinate of the position of the last significant coefficient is computed with respect to the corresponding coordinate of the predetermined position. For instance, if the coordinates of the predetermined position are (x2,y2) and the coordinate of the position of the last significant coefficient are (x1, y1), the processing module 500 of the systems 53 obtains a first coordinate X for the last significant coefficient equal to (x1−x2) if x1≥x2 ((x2−x1) if x1<x2) and a second coordinate Y for the last significant coefficient equal to (y1−y2) if y1≥y2 ((y2−y1) if y1<y2).

If a zeroing process was applied to the current block of transform coefficients, the processing module 500 of the system 53 decodes the position of the last significant coefficient in scanning order with respect to a position in the block depending on the applied zeroing process 703.

In some implementations using MTS, the signaling of the last significant coefficient with respect to zeroing process is not straightforward. Indeed, in these implementations, the decoding of MTS index (mts_index) signaling the type of transform applied to the block (among DCT-II, DST-VII and DCT-VIII) depends on the last significant coefficient. This is illustrated in table TAB3 describing a syntax of a coding unit (i.e. of a block) and table TAB4 describing a residual block decoding process, the two tables representing a specification corresponding to these implementations:

```
TABLE TAB3
coding_unit( x0, y0, cbWidth, cbHeight,
cqtDepth, treeType, modeType ) {
  MtsDcOnly = 1
  MtsZeroOutSigCoeffFlag = 1
  transform_tree( x0, y0, cbWidth, cbHeight, treeType, chType )
  if( treeType != DUAL_TREE_CHROMA && lfnst_idx = = 0
&& transform_skip_flag[ x0 ][ y0 ][ 0 ] = = 0
&& Max( cbWidth, cbHeight ) <= 32
&& IntraSubPartitionsSplitType = = ISP_NO_SPLIT
&& cu_sbt_flag = = 0
&& MtsZeroOutSigCoeffFlag = = 1 && MtsDcOnly = = 0 ) {
    if( ( ( CuPredMode[ chType ][ x0 ][ y0 ] = = MODE_INTER &&
    sps_explicit_mts_inter_enabled_flag)| |(
    CuPredMode[ chType ][ x0 ][ y0 ]
= =MODE_INTRA&& sps_explicit_mts_intra_enabled_flag ) ) )
        mts_idx
      }
    }
}
```

TABLE TAB4

```
residual_coding( x0, y0, log2TbWidth, log2TbHeight, cIdx ) {
  ...
  if( ( lastSubBlock > 0 | | lastScanPos > 0 ) && cIdx = = 0 )
    MtsDcOnly = 0
  ...
  for( i = lastSubBlock; i >= 0; i− − ) {
      CABACBypasIntervalAlign = 0
    startQStateSb = QState
    xS = DiagScanOrder[ log2TbWidth − log2SbW ]
    [ log2TbHeight − log2SbH ]
        [ i ][ 0 ]
    yS = DiagScanOrder[ log2TbWidth − log2SbW ]
    [ log2TbHeight − log2SbH ]
        [ i ][ 1 ]
    inferSbDcSigCoeffFlag = 0
    if( i < lastSubBlock && i > 0 ) {
      sb_coded_flag[ xS ][ yS ]
      inferSbDcSigCoeffFlag = 1
    }
    if( sb_coded_flag[ xS ][ yS ] && ( xS > 3
    | | yS > 3 ) && cIdx = = 0 )
      MtsZeroOutSigCoeffFlag = 0
    }
    ...
  }
...
```

As can be seen from tables TAB3 and TAB4, the MITS index (mts_idx) is only signaled when two conditions are fulfilled:
There is at least one more coefficient other than the DC value (specified by the condition (MtsDcOnly==0);
There is no coefficients beyond the first 16×16 coefficients (specified by the condition MtsZeroOutSigCoeffFlag==1).

Therefore, with these implementations, it cannot be known if MNTS was used to encode a block before knowing the position of the last significant coefficient. Consequently, the process applied to encode the position of the last significant coefficient of a block cannot be determined from the knowledge of the application of MITS on this block.

In a first embodiment of the method of FIG. 7, it is proposed to relax these two conditions to make the signaling of the last significant coefficient dependent on the MTS zeroing process. This embodiment is a modified version of a syntax proposed in the document Frank Bossen et al., “VVC operation range extensions (Draft 3)”, JVET-V2005. Joint Video Experts Team (JVET) of ITU-T SG 16 WP 3 and ISO IEC JTC 1/SC 29 22nd Meeting, by teleconference, 20-28 Apr. 2021.

In a first aspect of this first embodiment, a flag sh_reverse_last_sig_coeff_flag is added in the slice header to indicate the use of a modified last significant coefficient signaling as described in the document Fan Wang et al., “AHG8: on coding of last significant coefficient position for high bit depth and high bit rate extensions”, JVET-V0121. Joint Video Experts Team (JVET) of ITU-T SG 16 WP 3 and ISO/IEC JTC 1/SC 29 22nd Meeting, by teleconference, 20-28 Apr. 2021. This modification of the slice header is reflected in table TAB5.

TABLE TAB5

```
slice_header( ) {
    ...
    if(sps_range_extension_flag )
      sh_reverse_last_sig_coeff_flag
  ...
```

Then, in a second aspect of this first embodiment, the conditions on the MTS signaling are removed from the residual block decoding process as described in table TAB6. Changes with respect to the syntax of table TAB4 are represented in bold:

TABLE TAB6

```
residual_coding( x0, y0, log2TbWidth, log2TbHeight, cIdx ) {
  ...
  if( ( lastSubBlock > 0 | | lastScanPos > 0 ) && cIdx = = 0 ||
sh_{—}reverse_{—}last_{—}sig_{—}coef_{—}flag)
    MtsDcOnly = 0
  ...
  for( i = lastSubBlock; i >= 0; i− − ) {
      CABACBypasIntervalAlign = 0
    startQStateSb = QState
    xS =
DiagScanOrder[ log2TbWidth − log2SbW ]
[ log2TbHeight − log2SbH ]
        [ i ][ 0 ]
    yS =
DiagScanOrder[ log2TbWidth − log2SbW ]
[ log2TbHeight − log2SbH ]
        [ i ][ 1 ]
    inferSbDcSigCoeffFlag = 0
    if( i < lastSubBlock && i > 0 ) {
      sb_coded_flag[ xS ][ yS ]
      inferSbDcSigCoeffFlag = 1
    }
    if( sb_coded_flag[ xS ][ yS ] &&
    ( xS > 3 | | yS > 3 ) && cIdx = = 0 &&
sh_{—}reverse_{—}last_{—}sig_{—}coef_{—}flag == 0)
      MtsZeroOutSigCoeffFlag = 0
    }
    ...
  }
...
```

In a third aspect of this first embodiment, the process applied for deriving the coordinates of the last significant coefficient LastSignificantCoefX and LastSignificantCoefY is modified. In the first embodiment, the position of the last significant coefficient (LastSignificantCoeffX, LastSignificantCoeffY) is computed from the prefix and suffix with the following process (called MTS zeroing compliant derivation process in the following), the difference with respect to the basic derivation process being represented in bold:

| | |
|---|---|
| • | If last_sig_coeff_x_suffix is not present, the following applies: |
| | LastSignificantCoeffX = last_sig_coeff_x_prefix; |
| • | Otherwise (last_sig_coeff_x_suffix is present), the following applies: |
| | LastSignificantCoeffX = |
| | ( 1 << ( (last_sig_coeff_x_prefix >> 1 ) − 1 ) ) * |
| | ( 2 + (last_sig_coeff_x_prefix & 1 ) ) + |
| | last_sig_coeff_x_suffix; |
| • | If sh_{—}reverse_{—}last_{—}sig_{—}coeff_{—}flag is equal to “1”, the following |
| | applies: |
| | LastSignificantCoeffX = ( 1 << (mts_{—}idx !=0 ? 4 : log2ZoTbWidth) |
| | ) − 1- LastSignificantCoeffX; |
| • | If last_sig_coeff_y_suffix is not present, the following applies: |
| | LastSignificantCoeffY = last_sig_coeff_y_prefix; |
| • | Otherwise (last_sig_coeff_y_suffix is present), the following applies: |
| | LastSignificantCoeffY = |
| | ( 1 << ( ( last_sig_coeff_y_prefix >> 1 ) − 1 ) ) * |
| | ( 2 + ( last_sig_coeff_y_prefix & 1 ) ) + |
| | last_sig_coeff_y_suffix; |
| • | If sh_{—}reverse_{—}last_{—}sig_{—}coeff_{—}flag is equal to “1”, the following |
| | applies: |
| | LastSignificantCoeffY = ( 1 << (mts_{—}idx != 0 ? 4 : |
| | log2ZoTbHeight) ) − 1- LastSignificantCoeffY. |

As can be seen, when mts_idx is different from zero indicating that either a DST-VII or a DCT-VIII is applied in the horizontal (respectively vertical) direction (and consequently, the MTS zeroing process is applied), the horizontal (respectivelly the vertical) coordinate of the last significant coefficient LastSignifcantCoeffX (respectivelly LastSignifcantCoeffY) is computed with respect to a position in the block with an horizontal (respectivelly vertical) coordinate equal to “4”. It can be noted that in the MTS zeroing compliant derivation process the test “mts_idx !=0” corresponds to step 701 and the equation “LastSignificantCoeffX/Y=(1<<(mts_idx !=0 ? 4:log 2ZoTbWidth/Height))−1−LastSignifcantCoeffX/Y” when mts_idx>0 corresponds to step 703, the equation “LastSignifcantCoeffX/Y=(1<<(mts_idx!=0 ? 4:log 2ZoTbWidth/Height))−1−LastSignifcantCoeffX/Y” when mts_idx=0 corresponding to step 702.

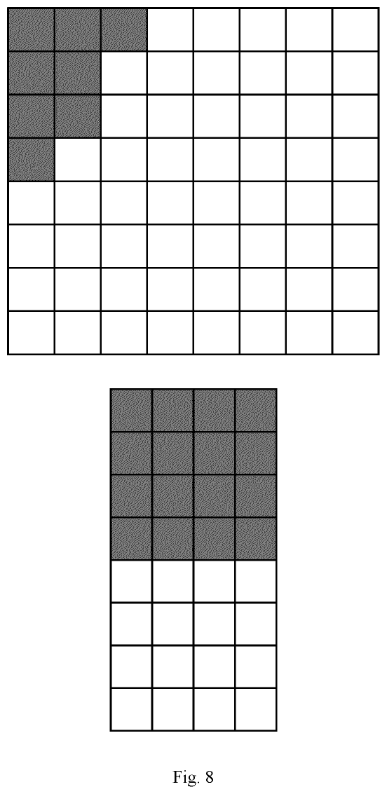

A second embodiment of the method of FIG. 7 addresses the case of a block encoded using LFNST. LFNST performs a zeroing process depending on the block dimension. If the transform block dimension is 4×4 or 8×8, only the first “8” coefficients are kept. Otherwise, for other block dimensions, the first 16 (4×4) coefficients are kept. Other transform coefficients are set to zero. FIG. 8 illustrates the zeroing process applied in LFNST. On the top, the grey squares indicate the positions of kept transform coefficients in 4×4 and 8×8 blocks (here only a 8×8 block is represented), other coefficients being set to zero by the zeroing process. On the bottom, the grey squares indicate the positions of kept coefficients in blocks having a dimension different from 4×4 and 8×8 (here a 8×4 rectangular block is represented), other coefficients being set to zero by the zeroing process.

Similarly to the MTS case, in some implementations, the signaling of LFNST depends also on the last significant coefficients, as represented in tables TAB7 and TAB8:

TABLE TAB7

```
coding_unit( x0, y0, cbWidth, cbHeight,
cqtDepth, treeType, modeType ) {
...
LfnstDcOnly = 1
LfnstZeroOutSigCoeffFlag = 1
  ...
if( Min( lfnstWidth, lfnstHeight ) >= 4 &&
sps_lfnst_enabled_flag = = 1 &&
    CuPredMode[ chType ][ x0 ]
    [ y0 ] = = MODE_INTRA && lfnstNotTsFlag
= = &&
  ( treeType = = DUAL_TREE_CHROMA | |
  !IntraMipFlag[ x0 ][ y0 ] | |
  Min( lfnstWidth, lfnstHeight ) >= 16 ) &&
  Max( cbWidth, cbHeight ) <= MaxTbSizeY) {
    if( ( IntraSubPartitionsSplitType != ISP_NO_SPLIT
    | | LfnstDcOnly = = 0
) &&
          LfnstZeroOutSigCoeffFlag = = 1 )
        lfnst_idx
      }
...
```

TABLE TAB8

```
residual_coding( x0, y0, log2TbWidth, log2TbHeight, cIdx ) {
  ...
  if( lastSubBlock = = 0 && log2TbWidth >=
  2 && log2TbHeight >= 2 &&
      !transform_skip_flag[ x0 ][ y0 ]
      [ cIdx ] && lastScanPos > 0 )
    LfnstDcOnly = 0
  if( ( lastSubBlock > 0 && log2TbWidth >= 2
  && log2TbHeight >= 2 ) | |
      ( lastScanPos > 7 && ( log2TbWidth = = 2
      | | log2TbWidth = = 3 ) &&
      log2TbWidth = = log2TbHeight ) )
    LfnstZeroOutSigCoeffFlag = 0
  ...
```

As can be seen, the LFNST index (lfnst_idx) is only signalled when the two following conditions are fulfilled (the LFNST index lfnst_idx specifies whether and which one of the two low frequency non-separable transform kernels in a selected transform set is used. lfnst_idx equal to “0” specifies that the low frequency non-separable transform is not used for the current block):
There is at least one more coefficient other than the DC value (specified by the condition LfnstDcOnly==0 in table TAB7);
No coefficients beyond the specified LFNST zeroing process (specified by the condition LfnstZeroOutSigCoeffFlag==1 in table TAB7).

To solve this issue, in a first aspect of the second embodiment, the flag sh_reverse_last_sig_coeff_flag is added to the slice header to indicate the use of a modified last significant coefficient signaling (as represented in table TAB9):

TABLE TAB9

```
slice_header( ) {
    ...
    if(sps_range_extension_flag )
      sh_{—} reverse_{—}last_{—}sig_{—}coeff_{—}flag
  ...
```

In a second aspect of the second embodiment, the conditions on the LFNST signaling are removed from the residual decoding process as represented in table TAB10 (the differences with respect to the table TAB8 are represented in bold).

```
TABLE TAB10
residual_coding( x0, y0, log2TbWidth, log2TbHeight, cIdx ) {
  ...
  if( lastSubBlock = = 0 && log2TbWidth >= 2 && log2TbHeight >= 2
&&
      !transform_skip_flag[ x0 ][ y0 ]
      [ cIdx ] && lastScanPos > 0 || sh_{—}
reverse_{—}last_{—}sig_{—}coeff_{—}flag)
    LfnstDcOnly = 0
  if( ( lastSubBlock > 0 && log2TbWidth >= 2 && log2TbHeight >= 2 )
| |
      ( lastScanPos > 7 && ( log2TbWidth = =
      2 | | log2TbWidth = = 3 )
&&
      log2TbWidth = = log2TbHeight ) && sh_{—}reverse_{—}last_{—}sig_{—}coef_{—}flag
== 0 )
    LfnstZeroOutSigCoeffFlag = 0
  ...
```

In a third aspect of the second embodiment, the process applied to derive the coordinates of the last significant coefficient LastSignificantCoefX and LastSignficantCoefY is modified. In the second embodiment, the position of last significant coefficient (LastSignificantCoeffX, LastSignificantCoeffY) is computed from the prefix and suffix with the following process (called LFNST zeroing compliant derivation process in the following), the difference with respect to the basic derivation process being represented in bold:

| | |
|---|---|
| • | If last_sig_coeff_x_suffix is not present, the following applies: |
| | LastSignificantCoeffX = last_sig_coeff_x_prefix; |
| • | Otherwise (last_sig_coeff_x_suffix is present), the following applies: |
| | LastSignificantCoeffX = |
| | ( 1 << ( (last_sig_coeff_x_prefix >> 1 ) − 1 ) ) * |
| | ( 2 + (last_sig_coeff_x_prefix & 1 ) ) + |
| | last_sig_coeff_x_suffix; |
| • | If sh_{—}reverse_{—}last_{—}sig_{—}coeff_{—}flag is equal to “1” and ApplyLfnstFlag |
| | is equal to “1”, the following applies: |
| | nonZeroSize = ( ( nTbW = = 4 && nTbH = = 4 ) \| \| ( nTbW = |
| | = 8 && nTbH = = 8 ) ) ? 8 : 16; |
| | LastSignificantCoeffX = (nonZeroSize == 8 ? 3 : 4) − 1 - |
| | LastSignificantCoeffX; |
| • | If last_sig_coeff_y_suffix is not present, the following applies: |
| | LastSignificantCoeffY = last_sig_coeff_y_prefix; |
| • | Otherwise (last_sig_coeff_y_suffix is present), the following applies: |
| | LastSignificantCoeffY = |
| | ( 1 << ( ( last_sig_coeff_y_prefix >> 1 ) − 1 ) ) * |
| | ( 2 + ( last_sig_coeff_y_prefix & 1 ) ) + |
| | last_sig_coeff_y_suffix; |
| • | If sh_{—}reverse_{—}last_{—}sig_{—}coeff_{—}flag is equal to 1 and ApplyLfnstFlag is |
| | equal to “1”, the following applies: |
| | LastSignificantCoeffY = 4 − 1 - LastSignificantCoeffY. |

It can be noted that the signaling processes for the horizontal coordinate LastSignificantCoeffX and for the vertical coordinate LastSignificantCoeffY are different. This is because the maximum horizontal position when the block dimension is 4×4 or 8×8 is “3” (top of FIG. 8), otherwise, it is “4” for other block dimensions (bottom of FIG. 8). The maximum value of the vertical position on its side is always “4”.

As can be seen, when the zeroing process of LFNST is applied, the horizontal (respectively the vertical) coordinate of the last significant coefficient LastSignificantCoeffX (respectively LastSignificantCoeffY) is computed with respect to a position in the block with an horizontal coordinate equal to “3” in case of block 4×4 and 8×8 and to “4” otherwise (respectively with a vertical coordinate equal to “4”).

It can be noted that in the LFNST zeroing compliant derivation process the test “ApplyLfnstFlag is equal to “1″” corresponds to step 701 and the equations “nonZeroSize=((nTbW==4 && nTbH==4)||(nTbW==8 && nTbH==8)) ? 8:16; LastSignificantCoeffX=(nonZeroSize==8 ? 3:4)−1−LastSignificantCoeffX” corresponds to step 703 for the horizontal coordinate, respectively the equation “LastSignificantCoeffY=4−1−LastSignificantCoeffY” corresponds to step 703 for the vertical coordinate. Step 702 is applied when the conditions “sh_reverse_last_sig_coeff_flag is equal to “1” and ApplyLfnstFlag is equal to “1″” are not fulfilled.

In a third embodiment of the method of FIG. 7, it is proposed to deactivate the signaling of the last significant coefficient position with respect to bottom right corner if LFNST is activated or MTS is activated with transform size greater than “16”. By doing so, it is ensured that there is no zeroing process that leads to a shift with respect to the bottom right corner.

In a first aspect of the third embodiment, the flag sh_reverse_last_sig_coeff_flag is added to the slice header to indicate the use of a modified last significant coefficient signaling as represented in table TAB11.

TABLE TAB11

```
slice_header( ) {
    ...
    if(sps_range_extension_flag && !sps_lfnst_enabled_flag )
      sh_ reverse_last_sig_coeff_flag
  ...
```

As can be seen from table TAB 11, the modified last significant coefficient signaling is allowed only when LFNST is not activated by a SPS (sequence parameter set, i.e. sequence header) level flag sps_lfnst_enabled_flag.

In a second aspect of the third embodiment, the process applied to derive the coordinates of the last significant coefficient LastSignificantCoefX and LastSignficantCoefY is modified. In the third embodiment, the position of last significant coefficient (LastSignificantCoeffX, LastSignificantCoeffY) is computed from the prefix and suffix with the following process (called LFNST & MTS zeroing compliant derivation process in the following), the difference with respect to the basic derivation process being represented in bold:

| | |
|---|---|
| • | If last_sig_coeff_x_suffix is not present, the following applies: |
| | LastSignificantCoeffX = last_sig_coeff_x_prefix; |
| • | Otherwise (last_sig_coeff_x_suffix is present), the following applies: |
| | LastSignificantCoeffX = |
| | ( 1 << ( (last_sig_coeff_x_prefix >> 1 ) − 1 ) ) * |
| | ( 2 + (last_sig_coeff_x_prefix & 1 ) ) + |
| | last_sig_coeff_x_suffix; |
| • | If sh_{—}reverse_{—}last_{—}sig_{—}coeff_{—}flag is equal to “1” and log2ZoTbWidth |
| | is less than or equal to “4”, the following applies: |
| | LastSignificantCoeffX = ( 1 << (log2ZoTbWidth) ) − 1- |
| | LastSignificantCoeffX |
| • | If last_sig_coeff_y_suffix is not present, the following applies: |
| | LastSignificantCoeffY = last_sig_coeff_y_prefix; |
| • | Otherwise (last_sig_coeff_y_suffix is present), the following applies: |
| | LastSignificantCoeffY = |
| | ( 1 << ( ( last_sig_coeff_y_prefix >> 1 ) 1 ) ) * |
| | ( 2 + ( last_sig_coeff_y_prefix & 1 ) ) + |
| | last_sig_coeff_y_suffix; |
| • | If sh_{—}reverse_{—}last_{—}sig_{—}coeff_{—}flag is equal to “1” and |
| | log2ZoTbHeight is less than or equal to “4”, the following applies: |
| | LastSignificantCoeffY = ( 1 << log2ZoTbHeight ) − 1- |
| | LastSignificantCoeffY |

It can be noted that in the LFNST & MTS zeroing compliant derivation process the tests “log 2ZoTbWidth is less than or equal to “4″” and “log 2ZoTbHeight is less than or equal to “4″” correspond to step 701 and the equations “LastSignificantCoeffX=(1<<(log 2ZoTbWidth))−1−LastSignificantCoeffX” and “LastSignificantCoeffY=(1<<(log 2ZoTbHeight))−1−LastSignificantCoeffY” correspond to step 703, step 702 being applied when the conditions sh_reverse_last_sig_coeff_flag is equal to “1” and log 2ZoTbWidth is less than or equal to “4” and “sh_reverse_last_sig_coeff_flag is equal to “1” and log 2ZoTbHeight is less than or equal to “4″” are not fullfilled.

FIG. 6 illustrates schematically an application of an embodiment during an encoding process.

The method of FIG. 6 is for example implemented by the apparatus 51, and more precisely by the processing module 500 of the apparatus 51.

In an embodiment, the apparatus 51 receives a RAW video sequence from the input modules 531 and encodes pictures of this RAW video sequence applying for example the method described in relation to FIG. 3. The method of FIG. 6 is applied during the encoding of a current block and more precisely during the signaling of the last significant coefficient of the current block after the transform and quantization of the current block in a block of transform coefficients. In FIG. 3, the signaling of the last significant coefficient occurs for example as a preliminary sub-step of the entropic coding step 310.

In a step 601, the processing module 500 of the apparatus 51 determines if a zeroing process (i.e. a zero out process) was applied to the block of transform coefficients. For example, the processing module 500 of the apparatus 51 determines if the current block was encoded using at least one of MTS or LFNST. Indeed, an application of at least one of these transform processes is an indication of an application of a zeroing process.

If no zeroing process was applied to the block of transform coefficients, the processing module 500 of the apparatus 51 signals the position of the last significant coefficient in scanning order with respect to a predetermined position in a step 603. For instance, the predetermined position is the top-left corner of the block if the sequence is encoded in low bitrate. The predetermined position is the bottom right corner of the block if the sequence is encoded in high bitrate.

If a zeroing process was applied to the block of transform coefficients, the processing module 500 of the apparatus 51 signals the position of the last significant coefficient in scanning order with respect to a position in the block depending on the applied zeroing process in a step 602.

In a first embodiment of the method of FIG. 6, the processing module 500 of the apparatus 51 applies a process for signaling the last significant coefficient compliant with the syntax, semantic and processes described in relation to the first embodiment of the method of FIG. 7.

In a fifth embodiment of the method of FIG. 6, the processing module 500 of the apparatus 51 applies a process for signaling the last significant coefficient compliant with the syntax, semantic and processes described in relation to the second embodiment of the method of FIG. 7.

In a sixth embodiment of the method of FIG. 6, the processing module 500 of the apparatus 51 applies a process for signaling the last significant coefficient compliant with the syntax, semantic and processes described in relation to the third embodiment of the method of FIG. 7.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof.
Creating and/or transmitting and/or receiving and/or decoding a bitstream or signal that includes one or more of the described syntax elements, or variations thereof
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.
A server, camera, cell phone, tablet or other electronic device that transmits (e.g. using an antenna) a signal over the air that includes an encoded video stream, and performs at least one of the embodiments described.
A server, camera, cell phone, tablet or other electronic device that tunes (e.g. using a tuner) a channel to transmit a signal including an encoded video stream, and performs at least one of the embodiments described.

1. A method comprising:
determining that a zeroing process is applied to a block of transform coefficients; and,
decoding a position of a last significant coefficient of the block in scanning order with respect to a position of a coefficient in the block, the coefficient being a last coefficient non-zeroed out by the zeroing process.

2. The method according to claim 1 wherein determining that a zeroing process is applied to a block of transform coefficients comprises determining that a zeroing process is applied based on a type of transform process applied to the block.

3. The method according to claim 1 comprising determining a type of zeroing process based on a type of transform process applied to the block.

4. (canceled)

5. A method comprising:
determining that a zeroing process is applied to a block of transform coefficients; and,
signaling a position of a last significant coefficient of the block in scanning order with respect to a position of a coefficient in the block, the coefficient being a last coefficient non-zeroed out by the zeroing process.

6. The method according to claim 5 wherein determining that a zeroing process is applied to a block of transform coefficients comprises determining that a zeroing process is applied based on a type of transform process applied to the block.

7. The method according to claim 5 comprising determining a type of zeroing process based on a type of transform process applied to the block.

8. (canceled)

9. A device comprising an electronic circuitry adapted for:
determining that a zeroing process is applied to a block of transform coefficients; and,
decoding a position of a last significant coefficient of the block in scanning order with respect to a position of a coefficient in the block, the coefficient being a last coefficient non-zeroed out by the zeroing process.

10. The device according to claim 9 wherein determining that a zeroing process is applied to a block of transform coefficients comprises determining that a zeroing process is applied based on a type of transform process applied to the block.

11. The device according to claim 9 wherein the electronic circuitry is adapted for determining a type of zeroing process based on a type of transform process applied to the block.

12. (canceled)

13. A device comprising an electronic circuitry adapted for:
determining that a zeroing process is applied to a block of transform coefficients; and,
signaling position of a last significant coefficient of the block in scanning order with respect to a position of a coefficient in the block, the coefficient being a last coefficient non-zeroed out by the zeroing process.

14. The device according to claim 13 wherein determining that a zeroing process is applied to a block of transform coefficients comprises determining that a zeroing process is applied based on a type of transform process applied to the block.

15. The device according to claim 13 wherein the electronic circuitry is adapted for determining a type of zeroing process based on a type of transform process applied to the block.

16. (canceled)

17. A non-transitory information storage medium storing a signal generated by the method of claim 5.

18. (canceled)

19. A non-transitory information storage medium storing program code instructions for implementing the method of claim 1.

20. A non-transitory information storage medium storing a signal generated by the device of claim 13.
